(19) United States
(12) Patent Application Publication
(10) Pub. No.: US 2004/0084408 A1
(43) Pub. Date: May 6, 2004

(54) Method for surface preparation to enable uniform etching of polycrystalline materials

(75) Inventors: Vladimir V. Makarov, Palo Alto, CA (US); William B. Thompson, Los Altos, CA (US); Theodore R. Lundquist, Dublin, CA (US)

Correspondence Address: Deborah W. Wenocur, c/o Lasagne Edwards, NPTest LLC, Legal Department, 150 Baytech Drive, San Jose, CA, 95134-2302, US

(73) Assignee: NPTEST, INC., SAN JOSE, CA

(21) Appl. No.: 10/420,675

(22) Filed: Apr. 21, 2003

Related U.S. Application Data
(63) Continuation-in-part of application No. 10/284,845, filed on Oct. 31, 2002.

(51) Int. Cl. B44C 1/22

(52) U.S. Cl. 216/62

(57) ABSTRACT

A method for surface preparation of a polycrystalline material prior to etching. The material surface is effectively amorphized by two particle beam bombardments on the material surface. These energized particles break the crystal structure of the crystalline material and convert it effectively into an amorphous material. The two particle beams are oriented to each other at an angle of at least twice of the critical angle of channeling for the most open crystal structure in the material. This ensures effective amorphization of the material surface regardless of the different grain orientations on the surface. The amorphized surface has isotropic surface properties and thus allows uniform etching at the second angle. The uniformity in surface properties allows better control over etching process and reduces damage to underlying and adjacent material.

### CROSS REFERENCE TO RELATED APPLICATION

This application is a continuation-in-part of U.S. patent application Ser. No. 10/284,845 by Vladimir Makarov et al, filed Oct. 31, 2002. The disclosure of the earlier application is hereby incorporated by reference in its entirety.

### BACKGROUND

The present invention relates generally to the etching of surfaces and thin films of polycrystalline materials. More specifically, it relates to a method for surface preparation by amorphization of grains within polycrystalline materials, such as the metallic interconnects, wires and planes employed in integrated circuits.

There are several techniques existing in the art that provide for localized surface etching. One of the most widely used methods is wet chemical etching wherein the surface to be etched is treated with specific chemical solutions. These chemical solutions react with the surface molecules and dissolve them.

Current state of the art in etching techniques includes dry or plasma etching as a substitute to the above-mentioned method. Dry etching utilizes plasma driven chemical reactions and/or reactive ion beams to remove material. There are several variations of the above-mentioned dry etching method known in the art such as, chemically assisted ion etching, reactive ion etching, ion-beam milling etc. U.S. Pat. No. 3,676,317, titled “Sputter etching process” assigned to Stromberg Datagraphix, Inc and U.S. Pat. No. 4,557,796, titled “Method of dry copper etching and its implementation” assigned to International Business Machines Corporation, discloses a method of dry etching.

However, the above etching techniques in general provide a uniform surface only if the surface properties are isotropic. In cases where the surface has polycrystalline grain structure, the grains at the surface have different crystallographic orientations. In many cases, such as for copper etch, the etch rates differ for the different crystallographic orientations. This leads to non-uniform material removal from the surface during the etching process.

A prior method used for attaining a uniform surface in monocrystalline materials for the purpose of achieving a uniform etch rate—is amorphization of the material surface prior to etching. Amorphization is the process by which the crystalline structure of a material is disrupted, i.e., the reduction of long-range order of a crystalline structure, resulting in an amorphous solid. This may be achieved by bombarding particle beams on the surface of the material; these energized particles interact with the atomic lattices and break the existing crystal structure. Thus the crystallographic orientation of the material surface is destroyed to get uniform surface properties. This enables uniform material removal from the surface of the material during the process of etching.

One such method has been disclosed in U.S. Pat. No. 6,303,472, titled “Process for cutting trenches in a single crystal substrate” assigned to STMicroelectronics S.r.I. In this method, the silicon substrate is amorphized prior to cutting trenches in the substrate. Another method has been disclosed in U.S. Pat. No. 5,436,174, titled “Method of forming trenches in monocrystalline silicon carbide” assigned to North Carolina State University. In this method, silicon carbide substrate is amorphized prior to etching process. The amorphization of the silicon carbide surface in the above invention aids in uniform etching of the surface.

However, the above inventions are only suited for amorphizaton of monocrystalline materials such as, silicon carbide, silicon etc. These inventions do not address the aforementioned problem of uniform etching of polycrystalline materials.

For example, ion beam etching of copper, which is normally a polycrystalline material, leads to strong roughness formation on the surface of etched copper. This is illustrated in FIG. 1. Polycrystalline material 100 is made up of several grains as illustrated in FIG. 1A. Three such grains 102, 104 and 106 have been shown in the figure. They have different orientations and are etched at different rates, resulting in an uneven texture as shown in FIG. 1B. Also, in the etching of thin films there is often preferential local etching of certain favorably oriented regions. In such cases, an etchant may penetrate the surface film and damage the underlying substrate material.

Ion beam etching can result in concurrent amorphization of the surface being etched, due to the interaction of the ion beam with the surface. However, even if the ion beam is of sufficiently high energy to break crystalline bonds and contribute to amorphization, in a polycrystalline material, certain grains may not be amorphized by the particle beam due to the “Channeling Effect”. The channeling effect occurs when atoms in a crystal are oriented in such a manner with respect to the ion beam, that a majority of ions pass between atoms or experience only weak collisions with the lattice atoms, deviate only weakly and move along “transparent” directions called “channels”. Thus, the beam passes into the lattice without substantially affecting the surface. Therefore, such grains retain their crystal structure while other grains with different orientations may be partially or completely amorphized. These crystalline grains generally require more time to be etched compared to the amorphized grains during the etching process. Thus grains that are amorphized can more readily be sputtered or etched, whereas those that retain their crystalline structure are more resistant to sputtering.

Many polycrystalline materials are used in integrated circuit processing. Polycrystalline metals like aluminum, copper, gold, silver, nickel, tungsten and titanium are widely used in vias and metallization. Other non-metallic polycrystalline materials such as polysilicon and polycrystalline dielectrics, are used in multiple applications. For patterning of microchips with an etching technique (such as—focused ion-beam etching (FIB)), uniform etch rate is critical in many situations. For example, in integrated circuits metallic interconnects are embedded in various layers of the substrate. In order to repair or edit an embedded metal interconnect in an integrated circuit from the frontside or the backside, the metal surface has to be exposed from under the overlayers of substrate followed by etching of the interconnect. The circuit components may be of the order of submicrons in size and therefore the process requires high precision to uniformly etch an embedded metal interconnect along its surface and through its vertical thickness.

Accordingly, there is a need for a method for surface preparation that can enable uniform etching, even in the case of polycrystalline materials. There is also a need for a method of amorphization of crystalline materials such that the channeling effect in grains is overcome in a more efficient manner. There is also a need for a method that can be used to improve the vertical precision in etching in the case of metallic interconnects embedded in layers of dielectric within the integrated circuits.

### SUMMARY

An object of the present invention is to prepare the surface of a polycrystalline material prior to etching, so as to ensure uniform etching of the material.

A further object of the present invention is to prepare the surface of a crystalline material prior to etching, so as to ensure better control over the etching process.

Another object of the present invention is to quicken the amorphization process by efficiently overcoming the channeling effect in crystalline structure.

Yet another object of the present invention is to amorphize the surface of a polycrystalline material using two particle beams.

The present invention utilizes two particle beams to bombard the material surface. These energized particles break the crystal structure of the material and thus convert the material into amorphous form. The two particle beams are inclined to each other at an angle of at least twice of the critical angle of channeling for the most open crystal structure in the material. These beams may or may not operate simultaneously on the operation region. This operation ensures that the grains on the material surface are amorphized irrespective of their orientations. Some grains are amorphized by bombardment at the first angle, and those that are not are amorphized by bombardment at the second angle. Amorphized surfaces have isotropic surface properties and therefore can be uniformly etched across the operation region. The uniformity in etching over the surface leads to more control and precision over the etching process. More control over the etching process leads to minimizing damage to underlying and adjacent material, including dielectrics, which protrude into and through the polycrystalline material during the etching process.

### BRIEF DESCRIPTION OF DRAWINGS

The preferred embodiments of the invention will hereinafter be described in conjunction with the appended drawings provided to illustrate and not to limit the invention, wherein like designations denote like elements, and in which:

FIG. 1A depicts a surface of a polycrystalline material prior to an etching operation;

FIG. 1B depicts the surface of the polycrystalline material after an etching operation in accordance with prior art;

FIG. 2 is a schematic representation of the etching process in accordance with a preferred embodiment of the current invention;

FIG. 3 depicts the amorphization process in accordance with a preferred embodiment of the current invention;

FIG. 4 illustrates the relative directions of the incident particle beams in case of overcoming plane channeling effect in materials.

FIG. 5A shows particle bombardment on a simple cubic lattice structure.

FIG. 5B shows particle bombardment on another simple cubic lattice structure in a different orientation.

FIG. 6 illustrates the two-angle amorphization arrangement used in the present invention.

FIG. 7 shows an application of the present invention in the case of embedded metallic surfaces in integrated circuits.

FIG. 8 illustrates an inverted pyramid structure.

FIG. 9a is a photograph of a copper surface etched without surface preparation according to the inventive method.

FIG. 9b is a photograph of a copper surface etched after surface preparation according to the inventive method.

### DESCRIPTION OF PREFERRED EMBODIMENTS

The present invention is a method for surface preparation of a polycrystalline material in order to enable uniform etching of the surface. This is done by amorphizing the surface of the material prior to or during the etching operation, by using particle beam bombardment onto the surface from at least two different angles with respect to the surface normal. In this manner, local non-uniformities in crystallographic orientation on the surface are destroyed, thereby inducing more isotropic surface properties such as a more uniform etch rate. This two-angle bombardment method overcomes the effect known as the “channeling effect”. When particles are incident onto a channel in the material, at an angle deviating from the channel angle by less than a critical value known as the critical angle of channeling, the majority of the particles do not experience strong interactions with the target atoms and therefore the crystal is said to be “transparent” in such directions. Due to the lack of strong interactions or collisions, the particles produce very little amorphization of the crystal. This is called the channeling effect.

The critical angle of channeling has been depicted as “θ_{c}” in FIG. 3. The critical angle of channeling “θ_{c}” can be defined as the maximum -angular deviation from the angle of a channel for which an ion (or particle) can enter a channel in a crystal structure without leaving it. As long as the component of the ion's energy perpendicular to the channel direction is smaller than the repelling potential of the atomic chain, the ion remains within the channel. For that to be fulfilled, the ion should move in a direction which is deviated from the direction of the channel by an angle less than the value of critical angle of channeling. The formulation for calculation of the critical angle of channeling can be obtained from M. T. Robinson in “Sputtering by Particle Bombardment I”, ed. R. Behrisch, Springer-Verlag, Berlin-Heidelberg-N.Y. 1981, p.99.

This angle depends only on the ion energy, its atomic number, the atomic number of the target atoms and a specific dimension parameter for the given channel which is a property of the given crystal structure. If critical angle of channeling for a material is known with respect to a particle beam, then critical angle of channeling for the same material, with respect to another particle beam can be calculated. The other particle beam can be of different energy or different particle type. If the two beams have different critical channeling angles, θ₁ and θ₂ respectively, the minimum inclination of the two particle beams to ensure amorphization is found to be θ₁+θ₂.

There are two kinds of channeling, axial channeling and plane channeling. In plane channeling, the incident particles move in a transparent direction limited by only two crystallographic planes, whereas in axial channeling, the particles move in a transparent direction limited by three or more crystallographic planes. Further details related to channeling and channeling effect can be obtained from J R Phillips, D P Griffis, and P E Russell, “Channeling effects during focused-ion-beam micromaching of copper”, J. Vac. Sci. Technol. A18 (2000) 1061.

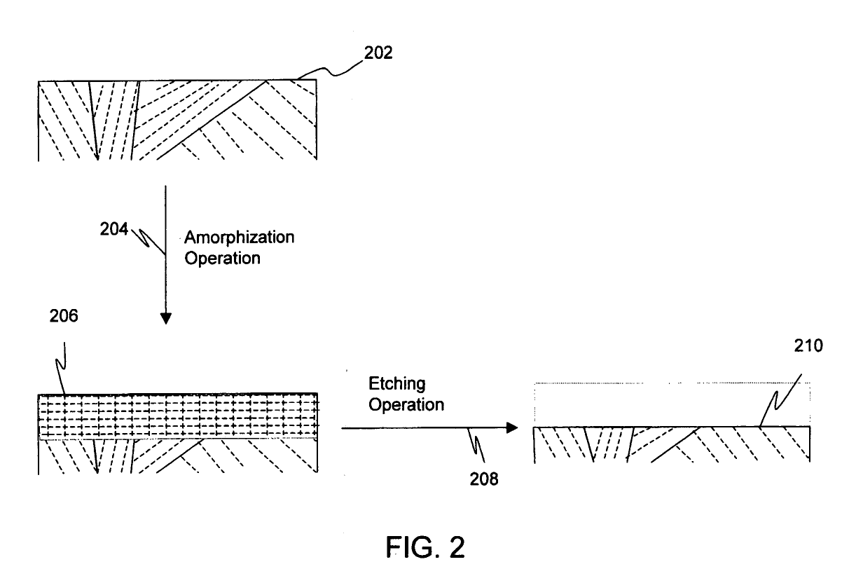

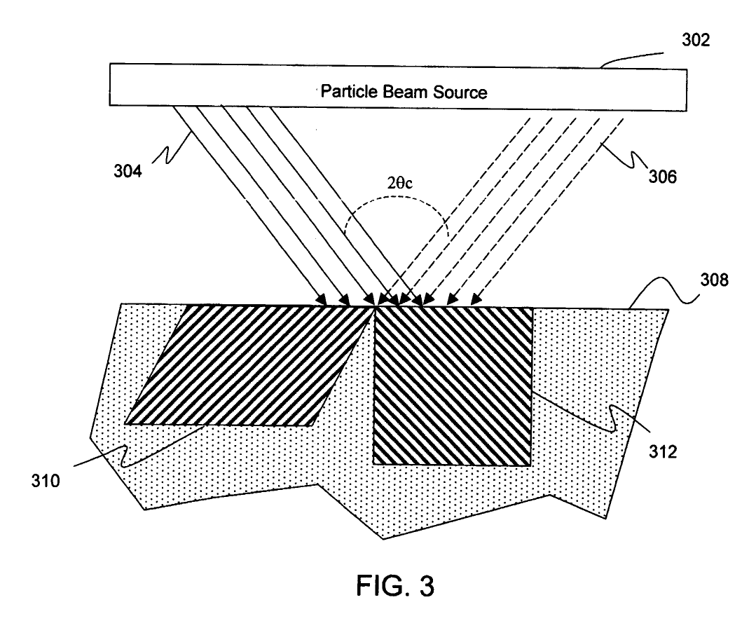

FIG. 2 is a schematic representation of the etching process in accordance with a preferred embodiment of the current invention. A substrate surface 202 to be etched is amorphized by an amorphization process 204 explained in greater detail in conjunction with FIG. 3. The amorphization process forms an amorphized layer 206 on the otherwise polycrystalline material. Amorphized layer 206 can thereafter be subjected to an etching operation 208. Etching operation 208 on amorphized layer 210 produces a uniformly etched surface 210.

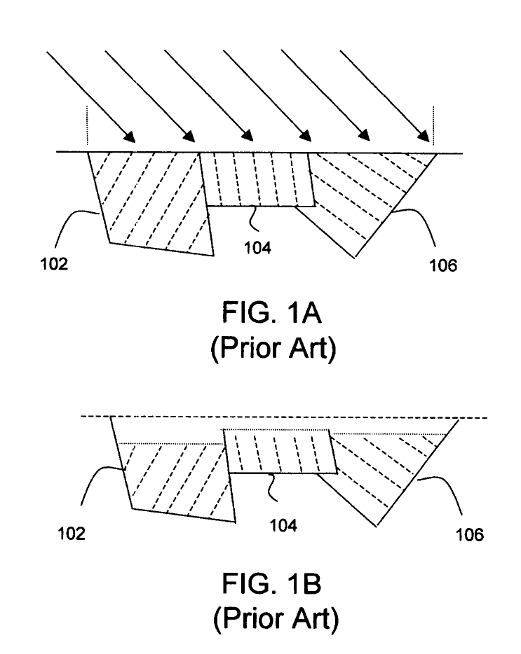

Surface 202 may constitute monocrystalline or polycrystalline material such as aluminum, copper, silver, gold, titanium, nickel, tungsten, polycrystalline dielectric or polysilicon. In case of a monocrystalline material, the atoms are arranged spatially in a regular repeating fashion. Such a material exhibits long-range order, i.e., the orientation of the atomic lattices is same across the entire crystal surface. In contrast, in a polycrystalline material, long-range order exists only within limited grains. Each such grain has a definite crystallographic orientation, different from its adjacent grains. A large number of such randomly arranged grains constitute the material. FIG. 1A depicts a typical surface in the case of polycrystalline material.

Amorphization operation 204 includes bombarding the surface of the substrate with one or more particle beams, to randomize long-range order. The bombarding beam comprises particles capable of strongly interacting with atomic lattices and breaking the bonds to render the surface amorphous. These particles may be, by way of example and not limitation, atoms, ions, neutrons, electrons, molecules etc. Exemplary particle beams include partially ionized gases such as an ionized argon beam.

FIG. 3 depicts the amorphization process in accordance with a preferred embodiment of the current invention. A particle beam source 302 generates particle beams 304 and 306, which are incident on and bombard surface 308. Particle beams 304 and 306 are inclined to each other at an angle that is at least twice the critical angle of channeling (i.e., 2θ_{c}).

In a preferred embodiment, only a single beam is used serially at two different angles to amorphize the operation region. Particle beam source 302 may be a commercially available ion beam generator capable of providing a particle beam of desired energy, mass and chemistry. It may also possess means for controlling the exposure time for amorphization and the flux of incident beam. A preferred embodiment of the invention uses a focused ion-beam (FIB) source. Description of a suitable FIB source may be found in U.S. Pat. No. 5,140,164, titled “IC modification with focused ion beam system” assigned to Schlumberger Technologies Inc. (San Jose, Calif.), incorporated herein by reference. However, the invention is not limited by any particular particle beam source. The incident ion beam size is not relevant; it may be broad or narrow, as long as it is directed. For applying the ion beam sequentially at two different angles, the sample may be placed on a movable tilt stage that allows its rotation/tilt. Alternatively, the beam may be moved with respect to the sample by changing the beam direction. Amorphization is achieved for those grains which do not have their channeling axis aligned with the incident beam. Those grains which do have their channeling axis aligned with the incident beam are not amorphized.

The channeling effect is overcome in this invention as shown in FIG. 3. There are two particle beams 304 and 306 that bombard material surface 308. Material surface 306 has two grains 310 and 312. The cross hatching shown in FIG. 3 for grains 310 and 312 depict the difference in orientation of the two grains. Particle beam 304 amorphizes the grains on the surface which are favorably inclined to it, i.e., inclined at an angle greater than or equal to the critical angle of channeling with respect to the crystallographic orientation of the grain, such as grain 310. Grains such as grain 312 that are not favorably inclined to particle beam 304, i.e. whose crystallographic orientation is inclined at an angle less than the critical angle of channeling with respect to beam 304, are not amorphized by it due to the channeling effect. However, grain 312 is amorphized by particle beam 306, which is inclined by at least twice the critical angle of channeling, to particle beam 304. Similarly beam 306 will have little effect on grain 310 but will amorphize grain 312. By using two beams inclined with respect to each other by at least twice the critical angle of channeling, effective amorphization of the substrate surface is obtained even in case of a polycrystalline surface with different grain orientations on the surface. In case of surfaces of polycrystalline materials, the two particle beams are inclined at an angle greater than twice the critical angle of channeling for the most open direction in the lattice of the material. Instead of using two different beams, a single beam operating at two different angles can also be used. The difference between the two angles should be at least twice the critical angle for channeling. In an alternative embodiment, a single particle beam can be incident on the polycrystalline material surface at an angle more than the critical angle of channeling to the surface normal. The polycrystalline material can then be azimuthally rotated so as to maintain same beam inclination with respect to the surface normal, i.e. greater than θ_{c}. Therefore, if we continuously rotate the polycrystalline material, complete amorphization of the material surface can be achieved.

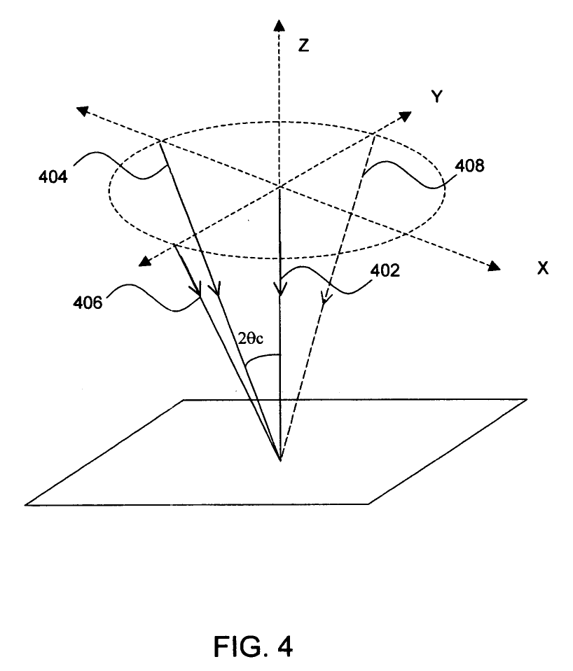

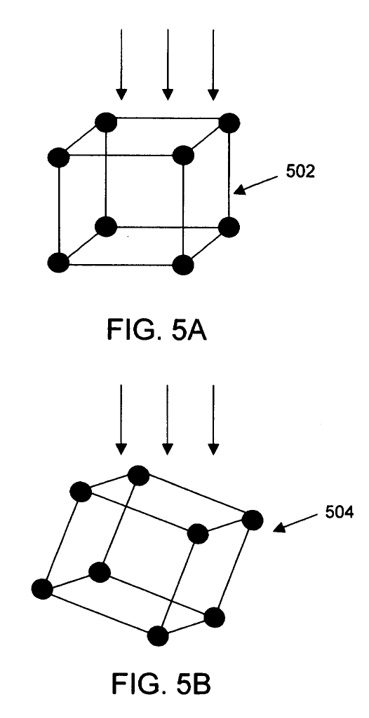

Azimuthal rotation can also be applied in the case of polycrystalline materials where plane channeling is dominant, or alternatively, an additional particle beam bombardment is used. When the plane formed by first and second stationary (i.e., with no azimuthal rotation) bombardment directions is inclined relative to the plane of the plane channel at an angle smaller than the critical angle of channeling, the first two bombardments do not completely amorphize the crystal structure. In this case an additional beam bombardment is required. The additional beam must be at an azimuthal angle different from the other two beams. In a preferred embodiment the difference in azimuthal angle is 90 degrees, however, azimuthal rotations by at least the plane channeling critical angle will be effective. FIG. 4 illustrates the relative directions of the incident particle beams to overcome plane channeling effect in materials. A particle beam 402 is directed along one axis in the Cartesian coordinate system (i.e. Z direction as shown in the FIG. 4). A second beam 404 is inclined at an angle twice that of the critical angle of channeling (2θ_{c}) to beam 402. Beam 404 has an azimuth angle equal to zero. A third beam is bombarded on the material surface. This third beam should have the same inclination to beam 402 as beam 404 but with an azimuth angle equal to +/−90 degrees i.e. the third beam should lie in the plane perpendicular to the plane formed by beams 402 and 404. Therefore, the third beam can be in any one of the directions 406 and 408, as shown in FIG. 4. This will provide amorphization in case of plane channeling.

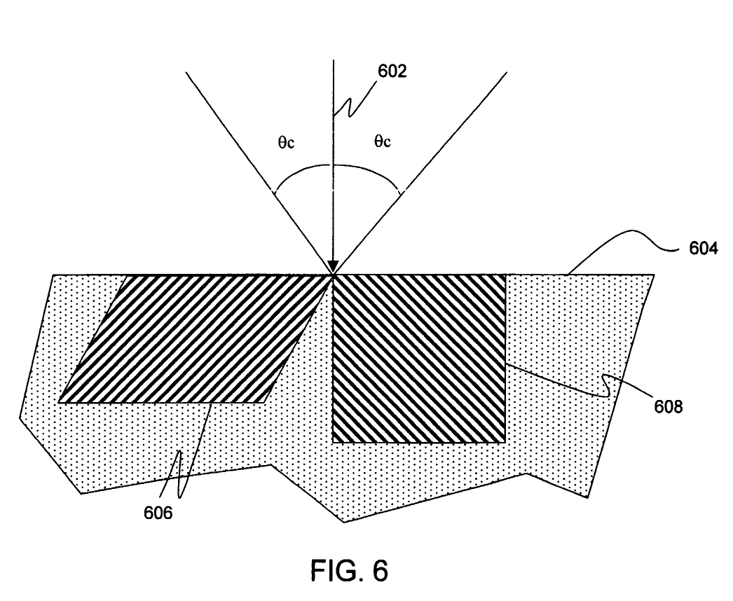

FIG. 5 illustrates two possible orientations of a crystal lattice structure in polycrystalline materials. FIG. 5A shows particle bombardment on a simple cubic lattice structure 502 in one of the orientations, while FIG. 5B shows particle bombardment on another simple cubic lattice structure 504 having a different orientation. During the process of amorphization, an ion beam is incident on the two lattice structures as shown in FIG. 5A and FIG. 5B. As can be seen from the figures, simple cubic structure 504 will provide greater obstruction to an ion beam passing through it as compared to simple cubic structure 502 because of the difference in orientations. A crystal lattice is said to be more open in a particular direction if the number of atoms packed per unit area facing in that direction is less as compared to the other direction. For example, simple cubic lattice 502 would be more open than simple cubic lattice 504 for the given particle bombardment. In case there exists a polycrystalline material with these two crystal orientations, for amorphization the inclination of the particle beam should be at least twice the critical angle of channeling for the most open lattice structure, e.g. the simple cubic structure 502.

FIG. 6 illustrates the two-angle amorphization arrangement used in the present invention. It shows the situation when a beam 602 is incident perpendicular to the surface of substrate 604. This operation amorphizes the grains whose open orientation is inclined to the surface normal by an angle equal or greater than the critical angle of channeling. Grains 606 and 608 have their open orientation inclined to the surface normal by an angle less than the critical angle for channeling “θ_{c}” but, opposite in directions to each other. In order that both grains were amorphized under the second bombardment, it is necessary that the second beam should strike at an angle at least twice the value of critical angle for channeling to the first beam. This ensures that the grains on the surface of the material are amorphized.

Although the amorphization process has been described as using two particle beams, it is apparent to one skilled in the art that multiple beams can also be used. Also, for monocrystalline surfaces, a single beam may be sufficient to amorphize the surface.

Solid geometrical considerations can affect the choice of bombardment angles used. By way of example, if the method is used for the amorphization and etching of large planar areas, there is no solid geometrical restriction on the available bombardment angles. Even in this case, however, the angular deviation between the two bombardments is generally chosen to be at the minimum effective value, i.e., twice the critical channeling angle. This is due in part to the fact that larger angle of incidence for the ion beam results in greater development of topography, which will shadow and protect the resistive grains from being etched. This development of topography is significant for thickness of copper greater than about one micron, and generally necessitates a multi-step process whereby the off-normal bombardment is alternated with normal bombardment accompanied by chemical etch assistance.

In contrast, For amorphization of a deeply buried narrow trace or line, as may be encountered in editing of metal lines by FIB, there will be angular restrictions in the available angle of incidence. These can arise from the shape of the milled FIB trench, which may be restricted, e.g., due to other intervening metal lines. Ideally, the particle beams should be tilted along the axis of the narrow trace so as not to affect higher-level metallizations and to avoid damage to the underlying and adjacent dielectric.

The particle beam bombardment which produces the surface amorphization produces additional concurrent effects which occur as a part of the surface preparation. A first concurrent effect is sputtering. The grains which are amorphized by the bombardment are more readily sputtered, and those grains which are not amorphized by the bombardment, i.e., those with channeling axes oriented along the angle of ion incidence, are more resistant to sputtering. A second concurrent effect has been seen with the particle beam bombardment, as in the case of FIB bombardment and imaging. This effect will be hereinafter referred to as “crystal growth at boundaries”. In FIB imaging the crystallites oriented to the incident ion beam so as to channel incoming ions appear dark on the image. In contrast, non-channeling crystallites appear bright on the FIB image. It has been observed that, under ion bombardment, the boundaries of the dark crystals enlarge with time. This is believed to indicate that the bombardment induces the atoms from the regions subject to amorphization to migrate to adjacent crystalline sites at the boundaries of the dark, i.e., channeling, crystallites. This type of crystallographic modification is expected to occur with other types of bombardment such as plasma beam bombardment, and is believed to have potential application in the growth of large-grain or single crystal PVD or CVD deposited films. PVD or CVD deposition of various types of polycrystalline films, if accompanied by concurrent ion beam or plasma beam bombardment, is believed will result in the growth of films with much larger grain sizes.

Following or alternatively during the bombardment which produces the amorphization, etching can be continued using any etching technique such as wet chemical etching, plasma etching, reactive ion beam etching and broad ion beam etching. For etching of thick films, the two different angles of bombardment may be alternated repeatedly.

In ion beam or plasma beam etching, one of the two particle beam bombardments, is generally carried out along with the etching process which usually involves a normal incidence ion beam accompanied by chemical enhancement. Thus, in this case, only one additional angle of particle beam bombardment, at an angle of at least twice the critical angle of channeling to the normal, is required, unless plane channeling occurs and necessitates an additional off-normal bombardment at a different azimuthal angle. The second, normal bombardment is carried out along with the etching process. The cycle of off-normal bombardment and normal bombardment with chemistry may be repeated several times, particularly in the case of thick films.

In a preferred method for exposing, bombarding, and etching a metal (e.g., copper) line using FIB, the steps include:

1) Exposing the metal line, e.g. by removing the material such as dielectric above the metal;

2) Performing an initial off-normal bombardment of the metal surface, generally by tilting the sample. This bombardment is preferably at the smallest possible angle which will amorphize metal grains which would show strong channeling under normal ion bombardment. As described herein, that smallest angle is generally twice the critical angle of channeling for the particular ions in the most open direction of the metal crystallites. The off-normal bombardment angle is minimized in this way in part to address the aforementioned restrictions in available angle of incidence, due to the tight geometries of IC's: the metallization, especially at deep layers, may have only a very limited angle of view. In the case where the angle of view is so limited that it is impossible to achieve off-normal bombardment at twice the critical channeling angle, bombardment at an off-axis angle less than twice the critical channeling angle will, it is believed, provide useful if not optimal results.

3) Normal incidence etching (with inherent simultaneous normal bombardment), generally in the presence of etch-assisting chemistry.

4) An optional second off-normal bombardment at different azimuthal angle, used in the occasional case of plane channeling.

5) Optional replacement of steps 2) and 3) by using a single off-normal bombardment and rotation of the sample

6) Optional repetition of steps 2-4 as needed.

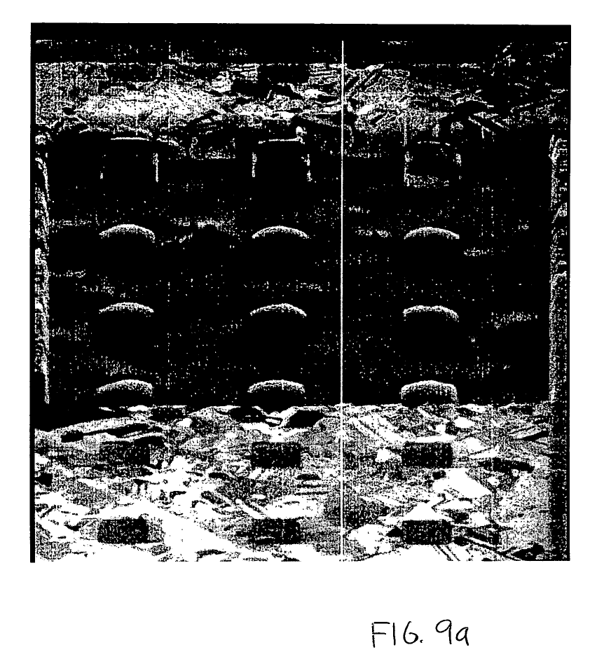

An embodiment of this invention utilizes a structure for frontside or backside editing which goes through several metal layers, known as a “terraced” structure or alternatively an “inverted pyramid” structure. This structure is illustrated in FIG. 8. Metal layers 802 and 804 are alternated with dielectric layers 806 and 808. Lower metal layer 802 is to be etched, e.g. for an editing process. Access to metal layer 802 is achieved by opening a larger dimension opening 810 through upper dielectric layer 812 and upper metal layer 804, and opening a smaller dimension opening 812 through lower dielectric layer 814. In this way, horizontal “terraces” 816 are created. This structure addresses two issues which arise during sputter etching of the lower metal layer. Firstly, it provides larger angular access to metal layer 802, as compared with a single smaller dimension opening through both dielectric layers and top metal layer 804. Secondly, it addresses the important issue of metal redeposition onto vertical walls during sputter etch, and is therefore useful for purely normal incidence bombardment as well as off-normal incidence. Use of the inverted pyramid structure reduces the problems resultant from redeposition in several ways:

1) Due to shadowing by lower vertical walls 818, there is little redeposition onto horizontal terraces 816 during sputter etch of metal layer 802. This lowers the probability that metal layers 802 and 804 will be shorted together due to redeposited metal on walls 818 and terraces 816.

2) Metal layers 802 and 804 are physically further separated, both by horizontal and vertical distance. This also decreases the probability of shorting.

3) Any metal redeposited on terraces 816 can be removed by normal incidence bombardment.

The inverted pyramid structure can be two-dimensional, for use in more open geometries, or it may be effectively a one-dimensional “slot” for use in very restricted geometries.

### EXAMPLE

In order to test and verify the effectiveness of the preliminary surface preparation using the two-angle amorphization scheme, a laboratory test was conducted. The test compared the results of Focused Ion Beam (FIB) etching of copper films with and without the use of the surface amorphization step prior to etching. Copper, being polycrystalline in nature, shows very uneven etching under normal conditions. An IDS P3X FIB instrument (available from NPTest, Inc) was used to generate a Focused Ion Beam of 30 keV Ga⁺ ions. The sample being tested consisted of a copper film deposited on a silicon dioxide dielectric on a silicon substrate. The copper film contained vertical silicon dioxide pillars coming out through the film and having height equal to the copper film thickness. These pillars were initially embedded into the copper film. The residuals of pillars were used to gauge the etching selectivity of copper over the dielectric. Ideally, etching of the copper film to a certain depth should be accompanied by minimum etching of the dielectric pillars.

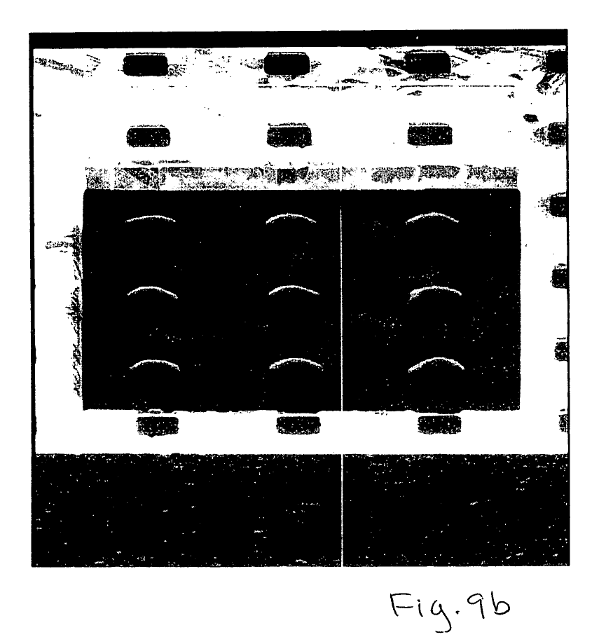

In one example, the etching operation was performed without preliminary surface preparation. The experimental sample was placed in a partial pressure of ammonia and water vapor, which acted as a copper etch assisting agent. Further details on the use of ammonia and water vapor as copper etch assisting agent, may be obtained from co-pending patent application Ser. No. 10/227,745, titled “Process for charged particle beam micro-machining of copper”, filed on Aug. 26, 2002, which is hereby incorporated by reference in its entirety. Owing to its polycrystalline grain structure, copper is etched with an ion beam very unevenly. Hence such copper-etch assistance agents need to be used to protect the underlying and adjacent dielectric material from damage in those areas where etching process proceeds faster. The ion beam impinged on the sample at normal incidence, and the ion beam current used was 1 nA. Under these experimental conditions, the sample took 58 minutes for a clean elimination of the copper film. The dielectric pillars were somewhat eroded. FIG. 9a is a FIB micrograph showing the copper surface following the etch.

The other sample was mounted on a tilt stage for allowing the tilting of the sample to angles between 0 and 60 degrees with respect to the ion beam. Etching using ion beam bombardment is performed at an angle (20 degrees) with respect to the first particle beam bombardment. In this case, the ion beam used for etching of the surface also acts as the second beam for amorphization.

The critical channeling angle for 30 keV Ga⁺ ions in the most open direction of copper was calculated to be approximately 10 degrees. The surface was first tilted and bombarded by the ion beam at a beam current of 1 nA. The exposure time was 5 minutes, during which, the sample was exposed to one ion beam tilted at an angle of 20 degrees to the surface normal. The etching operation was then carried out at normal incidence of the ion beam, in an atmosphere of ammonia and water vapors, as before. Under these experimental conditions, the sample took 33 minutes for complete copper elimination. The dielectric pillars were protected in a significantly better way. FIG. 9b is a FIB micrograph showing the copper surface following the etch.

A comparison of results of the two experiments shows that using the two-angle amorphization scheme disclosed by the invention a more uniform etching was achieved. The time for complete etching was significantly reduced, which also means that the dielectric pillars were subjected to the etching operation for a lesser period of time. The lower degree of damage to the dielectric pillars indicates this. Thus, for polycrystalline materials such as copper, surface preparation through amorphization results in better protection of underlying substrate and neighboring dielectric from damage.

In the sample that was subjected to the amorphization step of the present invention, the grain structure is disrupted on the entire surface and the entire operation region is uniformly oriented to etching. However, in case of the other sample, which was etched without surface preparation, there are some grains that are unfavorably oriented to etching. These unfavorably oriented grains take more time to etch away as compared to the favorably oriented grains thereby increasing the overall time required for complete etching.

Applications and Advantages

An application of the current invention is for polycrystalline films that need to be etched away uniformly. For example, copper, a polycrystalline material, is widely used as conductor material when making connections on semiconductor substrates, printed circuit cards, magnetic thin film heads etc. The conventionally used steps of photolithography for making these connections can be supplemented with the described method for achieving superior etching rates and etch quality. The amorphization of the material surface homogenizes the etching rates across the surface, thus ensuring more uniform etching. Using the inventive method, patterning and etching of copper lines may be able to replace Damascene processing in integrated circuit manufacturing.

This invention is also applicable to films that are not on a material surface but have been embedded in layers of materials, such as those found in the present generation of integrated circuits. These integrated circuits may comprise alternating layers of silicon dioxide (SiO₂) and patterned copper on a substrate of doped silicon. Other dielectric materials, for which the invention may be applicable, include, by way of example and not limitation, materials with low dielectric constants (k), such as organic silicon oxides, fluorinated silicon oxides, and various polymers and combinations thereof. Alternatively, these low-k dielectrics can be combined with silicon carbide, silicon nitride and silicon oxide. Still further examples of dielectric materials include fluorinated silicate glass (FSG), carbon-doped siloxanes or organosilicate glass (OSG), hydrogen silsesquioxane (HSQ), other silicon glasses, and combinations thereof. Materials with high-k for which the invention is applicable include hafnium oxide, silicon carbide, zirconium oxide, silicon monoxide, tantalum oxide, etc.

The metal interconnect is exposed by cutting a hole in the region above the metal interconnect surface, using standard material-layer removal techniques used in IC editing. Further information regarding etching techniques for IC editing can be obtained from H Ximen, C. G. Talbot, “Halogen-based selective FIB Milling for IC Probe-Point creation and repair”, 20^{th} ISTFA Proceedings 1994, 141. Subsequently, the method of etching as disclosed in the present invention can be carried out on the exposed metal surface.

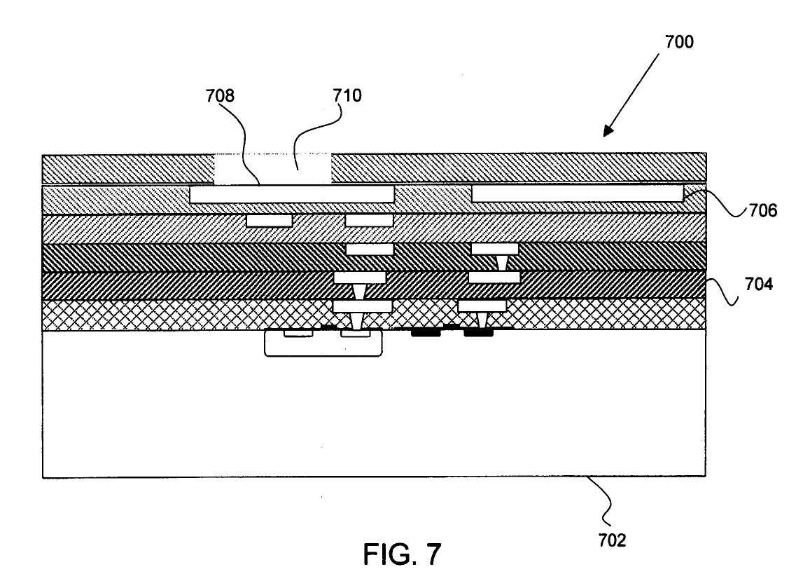

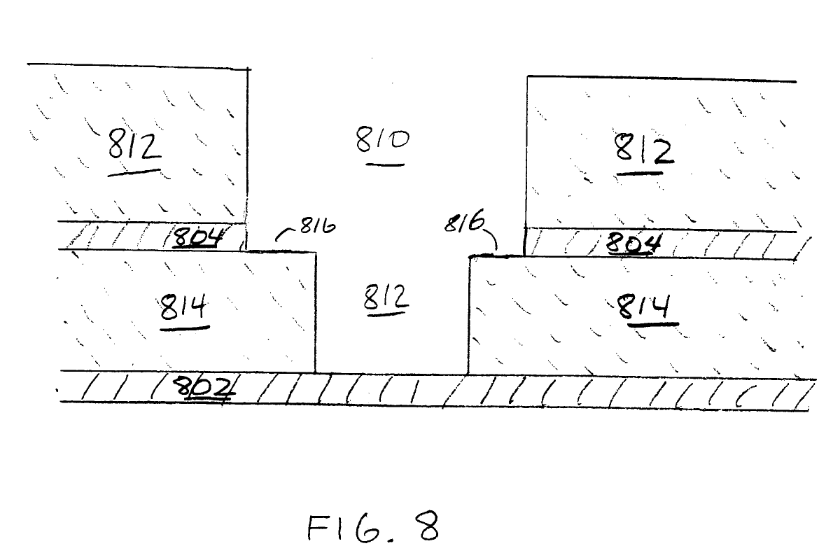

FIG. 7 shows the application of the present invention in case of embedded metallic surfaces in integrated circuits. A cross-sectional view of an integrated circuit 700 is shown. Integrated circuit 700 comprises a silicon substrate 702, silicon oxide layers 704 and metallic interconnects 706. An embedded metallic surface 708 is to be amorphized prior to etching. The insulator layer over metallic surface 708 is removed leaving a cavity 710. Thus the metal surface can be accessed and the process of etching as disclosed in the present invention can be carried out in case of embedded metallic interconnects.

For etch polishing a substrate surface prior to a thin film deposition, the use of the present invention results in clean and uniform surfaces, leading to good quality film deposition.

The present invention also provides better control over the etching process because of uniform etching across the surface achieved due to amorphization. Thus, the etching process can be more effectively controlled.

The use of the present invention leads to amorphization of the grains as the channeling effect is overcome. Therefore, the etching process using the present invention takes less time than etching using prior art methods.

The present invention can be utilized to improve existing processes and methods for etching of polycrystalline materials such as copper. The method of the present invention can also be automated, i.e., gas flows, pressure, temperature, sample tilt, time, can be controlled by a controller including a processor and a memory. Exemplary methods for automating of FIB systems are described in U.S. Pat. No. 5,140,164 by Talbot et al, issued Aug. 18, 1992, and in U.S. Pat. No. 6,031,229 by Keckley et al, issued Feb. 29, 2000. Both of these patents are hereby incorporated by reference in their entireties.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method for effective amorphization of a material surface, said material surface being comprised of a plurality of crystalline grains, said crystalline grains having at least one grain orientation relative to said material surface, said method using particle beam bombardment, the method comprising the steps of:
a. bombarding a first particle beam of a first particle type and having a first beam energy at the material surface, the first particle beam being inclined at a first angle to a normal to said material, said first particle beam amorphizing a first portion of the crystalline grains, a second portion of the crystalline grains remaining un-amorphized; and
b. bombarding a second particle beam of a second particle type and having a second beam energy, the second particle beam being inclined at a second angle to said normal to said material surface, said first particle beam and said second particle beam being inclined at a third angle relative to each other, the second beam amorphizing the second portion of the crystalline grains on the material surface.

2. The method of claim 1 wherein said third angle between the first particle beam and the second particle beam is at least the sum of a) the first critical angle of channeling for said material, said first particle type, and said first beam energy, and b) the second critical angle of channeling for said material, said second particle type, and said second beam energy.

3. The method of claim 2, wherein said first critical angle of channeling and said second critical angle of channeling have equal value, said equal value being denoted the critical angle of channeling.

4. The method of claim 1 further comprising the step of bombarding a third particle beam at an azimuth angle different from the azimuth angle of the first beam and the second beam by 90 degrees, to thereby overcome the plane channeling effect.

5. The method of claim 2 wherein the first particle beam is incident along the surface normal.

6. The method of claim 1 wherein the first particle beam and the second particle beam is a single beam serially incident at two different angles.

7. The method of claim 1 wherein the material surface is rotated thereby allowing the use of a single particle beam inclined at an angle to the surface normal for amorphization.

8. The method of claim 1 wherein said first and second particle beams are ion beams.

9. The method of claim 1 wherein the material is at least one of: a monocrystalline material and a polycrystalline material.

10. A method for material removal from a material surface, said material surface being comprised of a plurality of crystalline grains, said crystalline grains having at least one grain orientation relative to said material surface, the method comprising the steps of:
a. bombarding a first particle beam of a first particle type and having a first beam energy at the material surface, the first particle beam being inclined at a first angle to a normal to said material surface, said first particle beam amorphizing a first portion of the crystalline grains, a second portion of the crystalline grains remaining un-amorphized;
b. bombarding a second particle beam of a second particle type and having a second beam energy, the second particle beam being inclined at a second angle to said normal to said material surface, said first particle beam and said second particle beam being inclined at a third angle relative to each other, the second beam amorphizing the second portion of the crystalline grains on the material surface;
c. said amorphized first and second portions of crystalline grains forming an amorphized layer on said material surface; and
d. during or after step b), continuing the etching of said amorphized layer of said material surface.

11. The method of claim 10 wherein said third angle between the first particle beam and the second particle beam is at least the sum of a) the first critical angle of channeling for said material, said first particle type, and said first beam energy, and b) the second critical angle of channeling for said material, said second particle type, and said second beam energy.

12. The method of claim 10 wherein the particle beam is an ion beam.

13. The method of claim 10 wherein the material is at least one of: a monocrystalline material and a polycrystalline material.

14. The method of claim 10 wherein the solid is a metal interconnect embedded in an integrated circuit.

15. The method of claim 10 wherein the method is used to expose embedded metallization regions for editing.

16. The method of claim 10 wherein the step of continuing the etching of said amorphized layer is performed using a process selected from a group consisting of ion beam etching, plasma beam etching and wet etching.

17. The method of claim 10 wherein the step of continuing the etching of said amorphized layer is performed using focused particle beam etching.

18. The method of claim 10 wherein the step of continuing the etching of said amorphized layer acts as the second particle beam for amorphization.

19. The method of claim 10 wherein the method is used to cut narrow traces.

20. A method for surface preparation to enable uniform etching of a material surface, said material surface being comprised of a plurality of crystalline grains, said crystalline grains having at least one grain orientation relative to said material surface, the method comprising the steps of:
a) bombarding a first particle beam of a first particle type and having a first beam energy at the material surface, the first particle beam being inclined at a first angle to a normal to said material surface, said first particle beam amorphizing a first portion of the crystalline grains, a second portion of the crystalline grains remaining un-amorphized; and
b) bombarding a second particle beam of a second particle type and having a second beam energy, the second particle beam being inclined at a second angle to said normal to said material surface, said first particle beam and said second particle beam being inclined at a third angle relative to each other, the second beam amorphizing the second portion of the crystalline grains on the material surface.

21. The method of claim 20 wherein said third angle between the first particle beam and the second particle beam is at least the sum of a) the first critical angle of channeling for said material, said first particle type, and said first beam energy, and b) the second critical angle of channeling for said material, said second particle type, and said second beam energy.

22. The method of claim 20 wherein the particle beam is an ion beam.

23. The method of claim 20 wherein the material is at least one of: a monocrystalline material and a polycrystalline material.

24. The method of claim 20 wherein the material is a metal interconnect embedded in an integrated circuit.

25. A method of frontside editing of an integrated circuit, said method including the etching of a polycrystalline conducting feature having a surface including crystalline grains, said polycrystalline conducting feature being separated from an adjacent conducting feature by an insulating layer, said method comprising:
a) exposing said polycrystalline conducting feature;
b) bombarding said surface of said polycrystalline conducting feature with a first particle beam of a first particle type and having a first beam energy, the first particle beam being inclined at a first angle to a normal to said surface of said polycrystalline conducting feature, said first particle beam amorphizing a first portion of the crystalline grains, a second portion of the crystalline grains remaining un-amorphized;
c) bombarding said surface of said polycrystalline conducting feature with a second particle beam of a second particle type and having a second beam energy, the second particle beam being inclined at a second angle to said normal to said surface of said polycrystalline conducting feature, said first particle beam and said second particle beam being inclined at a third angle relative to each other, the second beam amorphizing the second portion of the crystalline grains;
d) during or after step c), continuing the etching of said polycrystalline conducting feature; and
e) repeating steps b)-d) as needed.

26. The method of claim 25, wherein said step of exposing said polycrystalline conducting feature includes opening an inverted pyramid opening above said polycrystalline conducting feature.

27. The method of claim 1, wherein said bombardment with said first and said second particle beams is achieved by tilting said sample with respect to said first particle beam and azimuthally rotating said sample with respect to said first particle beam.

28. A method of growing at least one of PVD and CVD films onto a substrate, said films having large grain size, said method comprising providing fixed bombardment of said substrate with a beam comprising at least one of ion beams and plasma beams during said film growth.

29. The method of claim 1, wherein said steps of bombarding said material surface are controlled by an automated controller.

30. A system for surface preparation to enable uniform etching of a material surface of a sample, said material surface being comprised of a plurality of crystalline grains, comprising:
a) a sample holder for holding said sample in the path of a bombarding particle beam;
b) a particle beam source arranged to direct a particle beam onto said sample at variable angles to a normal to said material surface of said sample;
c) a system controller configured to control the bombardment of said sample by said particle beam; and
d) a memory coupled to the controller comprising a computer-readable medium having a computer-readable program embodied therein for directing operation of the system, the computer-readable program comprising:
instructions for controlling the particle beam source and the sample holder to direct the particle beam onto said material surface at a plurality of angles to a normal to said material surface, to prepare said material surface so as to enable uniform etching of said material surface.

31. A machine readable storage medium containing executable program instructions which when executed cause a digital processing system to perform a method for effective amorphization of a material surface, said material surface being comprised of a plurality of crystalline grains, the method comprising the steps of:
a) bombarding a first particle beam of a first particle type and having a first beam energy at the material surface, the first particle beam being inclined at a first angle to a normal to said material, said first particle beam amorphizing a first portion of the crystalline grains, a second portion of the crystalline grains remaining un-amorphized; and
b) bombarding a second particle beam of a second particle type and having a second beam energy, the second particle beam being inclined at a second angle to said normal to said material surface, said first particle beam and said second particle beam being inclined at a third angle relative to each other, the second beam amorphizing the second portion of the crystalline grains on the material surface.
